(19) United States
(12) Patent Application Publication
(10) Pub. No.: US 2018/0249758 A1
(43) Pub. Date: Sep. 6, 2018

(54) Dynamically Responsive Smoking Apparatus and Method of Affixing Electronics Thereon

(71) Applicants: Moses Derkalousdian, Escondido, CA (US); Sergio Estrada, San Diego, CA (US); William R. Westwood, Escondido, CA (US)

(72) Inventors: Moses Derkalousdian, Escondido, CA (US); Sergio Estrada, San Diego, CA (US); William R. Westwood, Escondido, CA (US)

(73) Assignee: SMB Labs, LLC, San Diego, CA (US)

(21) Appl. No.: 15/450,000

(22) Filed: Mar. 5, 2017

(51) Int. Cl. A24F 3/00; H05B 33/08; G08B 7/00

(52) U.S. Cl. CPC A24F 3/00; G02B 6/0096; G08B 7/00; H05B 33/0848

(57) ABSTRACT

An apparatus comprising an input sensor and an output response configured to dynamically respond to readings from the input sensor, as well as methods of affixing electronics comprising an input sensor to an apparatus, wherein an apparatus may comprise a smoking device, an input sensor may comprise a temperature sensor, and an output response may comprise a lighting effect.

### TECHNICAL FIELD

This disclosure generally relates to smoking devices that dynamically respond in real time to user or environmental interactions.

### BACKGROUND

Smoking devices vary greatly in shape and materials, but a common thread among them is the presence of a receptacle (where the smoking material is retained), a stem (which may include a long flexible tube as on hookahs, or a shorter conduit as in pipes), and a mouthpiece. The smoking material is placed in the receptacle and affected with a heat source while air is drawn through the receptacle and stem to the user.

Smoking devices can be constructed with a variety of materials, including metal fittings, ceramic, borosilicate glass, uranium glass, stone, wood, and bamboo, among others. Hand pipes, for example, are made with an eye toward aesthetics, with many pipe makers blurring the line between function and art. Many who appreciate the aesthetic value of pipes and other smoking devices tend to express themselves through the unique designs of their personal pieces, and as a result, there are many distinctive characteristics that have attached themselves to modern designs, all in the name of aesthetics, art, and entertainment.

One common characteristic of designs that are presently available is that they are static and exist independently of the smoking device's functional aspects. The colors, materials, and designs do not change as the person uses the device. There continues to be a need for more dynamic designs in the field of smoking devices.

### SUMMARY

Embodiments of a smoking device are described in which the device exhibits real time reactive responses to user or environmental interactions. By using electronic components, the smoking device can sense various conditions within the smoking device or its vicinity, process the conditions, and drive various outputs according to the processing in real time.

In some embodiments, a sensor may sense one or more sensor readings. A processor may determine whether the one or more sensor readings exhibit certain characteristics associated with an act of smoking, and if they do, the processor may cause an electronic component to respond.

In some embodiments, an electronic component may include a light source. In other embodiments, an electronic component may include an audio source, a motor, or an actuator. Further, in some embodiments, a sensor may sense one or more temperature levels, while in other embodiments, a sensor may sense one or more air pressure levels, flow levels, lighting levels, or touch levels.

### BRIEF DESCRIPTION OF DRAWINGS

FIG. 1 depicts a functional diagram of an example smoking device that may implement hardware aspects described in this disclosure.

FIG. 2 depicts a generic diagram of a smoking device illustrating air flow during a smoking event, as well as an example placement of a sensor.

FIG. 3 depicts an embodiment for sealing an input sensor into an interior region of an example smoking device made out of glass or a similar substance.

FIG. 4 depicts another embodiment for sealing an input sensor into an interior region of an example smoking device made out of glass.

FIGS. 5A and 5B depict two views of an embodiment for joining a housing of electronic components to a glass body of a smoking device by using a stamp.

FIGS. 6A and 6B depict two embodiments for joining a housing of electronic components to a body of a smoking device by using at least one magnet.

FIG. 7 depicts an embodiment for joining a housing of electronic components to a body of a smoking device by using a strap.

FIG. 8 depicts an embodiment for joining a housing of electronic components to a body of a smoking device by using threading.

FIGS. 9A and 9B depict embodiments for joining a housing of electronic components to a body of a smoking device by using a mounting plate.

FIG. 10 depicts an embodiment of a smoking device made out of glass and including lasers and strategically placed mirrors.

### DETAILED DESCRIPTION

This disclosure includes several embodiments of a smoking device that responds dynamically to various user or environment inputs.

As used herein, the term “smoking device” may refer to any device comprising a receptacle for retaining a smoking substance, and a stem for directing airflow from the receptacle to a user's mouth. One example of a smoking device is a hand pipe (also known as a pipe, glass pipe, spoon, chillum, or tobacco bowl), which can be made out of glass, metal, wood, or a combination thereof. Hand pipes are hand held smoking devices that feature a mouthpiece, a stem, and a “bowl” used to contain the herbs or tobacco. An upper part of the bowl is open to the air, and a lower part of the bowl is designed to be held above a heat source so that the smoking substance inside the bowl combusts, releasing compounds into the air. When a person inhales from the mouthpiece, those compounds follow the airflow through the stem and into the mouth. Such pipes can include a “carb” or carburetor to allow for additional control of airflow and intensity of smoke traveling through the pipe from the bowl to the mouthpiece. Other nonlimiting examples of smoking devices may include hookahs, bubblers, water pipes, and bongs.

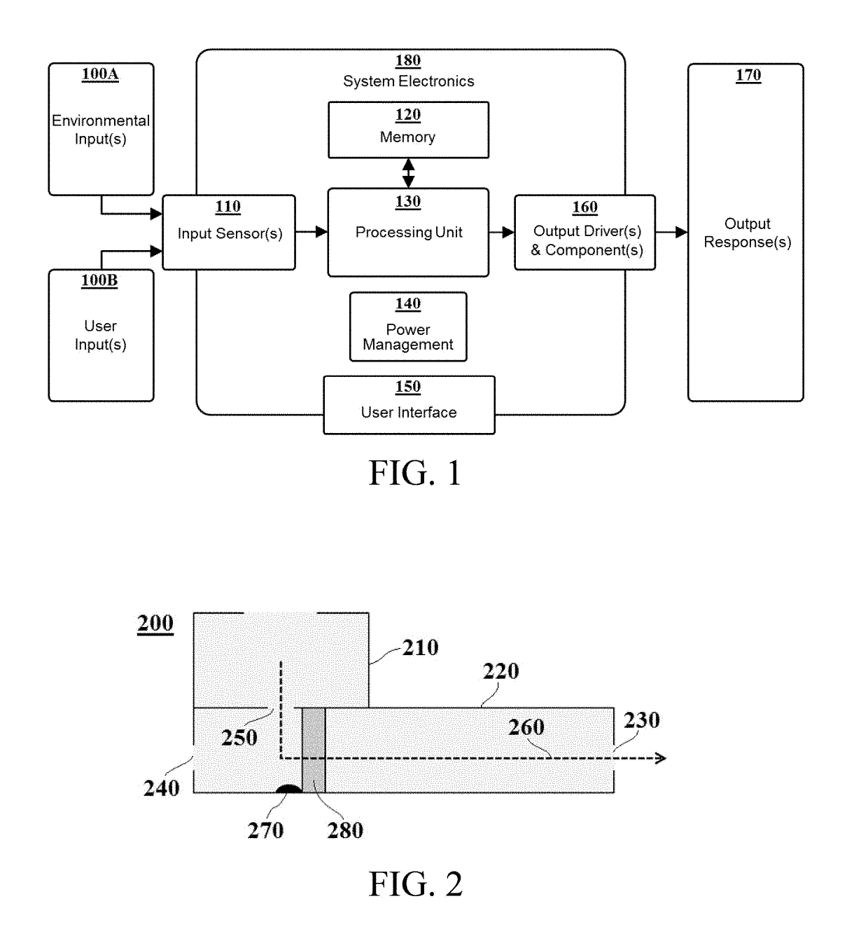

FIG. 1 depicts a functional diagram of an example smoking device. System electronics 180 can be configured to detect one or more environmental inputs 100A, one or more user inputs 100B, or a combination thereof, and drive one or more output responses 170 as a result of the one or more detections. System electronics 180 can include one or more input sensors 110, memory 120, processing unit 130, power management 140, user interface 150, and one or more output drivers or components 160.

Environmental inputs 100A are inputs to the smoking device from the environment surrounding the smoking device which can trigger one or more of the various output responses. Examples of environmental inputs 100A may include music playing, ambient light, and ambient temperature.

User inputs 100B are inputs to the smoking device by a user which can trigger one or more of the various output responses. One example of a user input 100B may include user pull, draw, or inhalation of air or smoke through the smoking device. Any time air begins to flow through the smoking substance toward an outlet in the stem, this may be a user input 100B. Another example of a user input 100B may include a user's hand coming into contact with the smoking device. A further example of a user input 100B may include application of an external heat source by the user; for example, when the user ignites a smoking substance in the receptacle with a lighter or any other source of heat, this may be a user input 100B.

One or more input sensors 110 can be used to monitor one or more environmental inputs 100A or one or more user inputs 110B. Several nonlimiting examples of an input sensor 110 can include a temperature sensor, such as a thermistor or thermocouple; an airflow or flow sensor, such as a MEMS or traditional electro-mechanical sensor; a pressure sensor; an audio sensor, an accelerometer; or a light sensor, such as a photodetector, infrared thermometer, or pyrometer. A temperature sensor may sense temperature levels inside or in the vicinity of the stem. As the user draws heated air through the stem, the temperature sensor may output one or more temperature readings reflecting changes in temperature. While a temperature sensor may require a heated smoking substance, various other sensors could work even when heat is not applied. For example, an airflow sensor can sense air flowing from the receptacle through the stem. A pressure sensor can sense changes in air pressure as the stem fills with air. An audio sensor can detect sounds associated with a user inhaling through a mouthpiece, a user lighting the smoking substance (sounds associated with a lighter clicking on or a match striking a match box), or combustion (crackling sounds associated with a smoking substance having been exposed to a heat source). A light sensor can detect a glow of the smoking substance as it is heated during pull, draw, inhalation, or ignition. A pyrometer or infrared temperature sensor can sense one or more temperatures of the smoking substance, air inside the smoking device, or material making up the smoking device.

Processing unit 130 can include a processor that runs software which can be stored in a separate memory 120 or within the processing unit itself. The software can comprise instructions which control the processing unit to carry out various functions, such as those outlined in this disclosure. For example, the instructions can control processing unit 130 to read input readings from input sensor(s) 110 and generate corresponding output responses by interacting with output driver(s) or output component(s) 160. Processing unit 130 can also communicate with an optional user interface 150 to facilitate user interaction and control. Software stored in memory 120 or processing unit 130 can include control logic, drivers, and various algorithms used to interact with system electronics 180. In an alternative embodiment, system electronics 180 need not include processing unit 130, and instead can comprise an analog circuit with a temperature-sensitive component such as a bimetallic strip, and an analog switching component such as a transistor. As the bimetallic strip responds to changes in temperature, it closes or opens a circuit which causes current to begin or cease flowing into the base or gate of the transistor, which causes the transistor to begin or cease conducting current through an output component such as an LED, or any other output component that responds to changes in electronic current. In this alternative embodiment, a temperature change can directly cause an output response without the need for a digital processing unit.

One or more output drivers or components 160 can be configured to control one or more output responses 170. In one embodiment, processing unit 130 can output a control signal to an output driver which controls an output component according to the control signal. In another embodiment, processing unit 130 can output a control signal directly to an output component. In the latter embodiment, output drivers are not required. In the former embodiment, an output driver can contain electronics that convert control signals from processor 130 to output signals that can drive an output component 160, which is useful when the output component cannot communicate directly with a processing unit. For example, an output driver can include an audio codec to control a speaker for audio output. As another example, a light emitting diode (LED) driver can control brightness of an LED. In further examples, a motor driver can control a motor, and an actuator driver can control and actuator. In an alternative embodiment, system electronics 180 need not include output drivers. Output responses can instead be driven directly by the processing unit or other components. For example, an output signal from processing unit 130 can directly control an output component such as an LED without the need for an output driver such as an LED driver.

One or more output responses 170 can be generated in real time in response to an input 100. Possible nonlimiting examples of an output response can include a lighting response, an audio response, a tactical response, or an actuation response.

In a lighting output response embodiment, an output component 160 can include a light source, and an output response 170 can include a light output. A light source can include any component that emits light, and can emit visible, infrared, or ultraviolet wavelengths. One example of a visible light may include a multi-color red-green-blue (RGB) light, which allows multiple colors to be emitted from a single light. One example of an ultraviolet light may include a blacklight, which emits mostly ultraviolet wavelengths and some visible wavelengths. Ultraviolet or infrared light can be used to illuminate glass for additional presentation. However, a light source can include any combination of one or more lights emitting wavelengths in any range of the electromagnetic spectrum. In one embodiment, a light source can include an LED. In another embodiment, a light source can include a laser. In some embodiments, light from any type of light source can emanate through a light pipe, fiber optic, mirror, or natural diffusion through glass present in the smoking device. In other embodiments, light may emanate directly from the light source to the environment outside of the smoking device. In an embodiment including a laser, light from the laser can be routed through the smoking device using reflecting mirrors which guide laser light back and forth through the smoking device multiple times. In some embodiments, a light source can be fixed to the smoking device, while in other embodiments, a light source can be placed independent of the smoking device. An example of fixed lighting can include a light source mechanically coupled to the smoking device. An example of independent lighting can include a light source in a vicinity of the smoking device, communicatively coupled to the smoking device by, for example, a wireless communications platform.

A lighting output response can include fixed intensity, variable intensity over time, intensity that is based on an input 100, or any combination thereof. A result of a variation in intensity can include a variation in brightness or a change of color. If output component 160 includes a plurality of light sources physically spaced apart, a result of a variation in intensity can also include a variation in lighting pattern, causing a spatial animation. For example, a plurality of LEDs oriented in a shape or pattern can be animated to display an animated motion by turning on or off subsequent LEDs along a direction of the shape or pattern. A speed or color of an animation can vary based on an input 100. For example, in an embodiment in which sensor 110 senses temperature and output component 160 includes a plurality of light sources arranged in a circle, a rotational animation around a circumference of the circle may increase in speed as temperature increases. As another example, a plurality of lighting animations can be included in a lighting output response—one which responds to an input 100, and another which varies continuously over time in response to an input or independent of any input. Variations in lighting intensity can be driven by analog circuitry controlled by processing unit 130, or through a Pulse Width Modulation (PWM) component. It is appreciated that embodiments of the invention can include any combination of light variations in terms of brightness, color, and lighting pattern, and the examples used to describe specific colors or patterns are not meant to be limiting. It is further appreciated that embodiments for lighting output response variations are not restricted to being in response to an input sensor reading. For example, a lighting output can vary independently of any input sensor readings. Further, a lighting output can include a background animation which runs independently of any input sensor readings (i.e. a background lighting output), while another lighting output can respond to a sensor input (i.e. a user lighting output), wherein the background lighting output variations and the user lighting output variations are mutually exclusive.

In an audio output response embodiment, an output component 160 can include a speaker, and an output response 170 can include an audio clip. Examples of subject matter for an audio include a musical selection (anywhere from a short clip of a song to longer playback of a playlist), and a sound effect (buzzing, pulses, tones, etc.). The playback volume of the aforementioned subject matter can be fixed, vary over time, or vary based on input 100.

In a tactical output response embodiment, an output component 160 can include a vibration motor, and an output response 170 can include a vibration. In some embodiments, vibrations caused by the vibration motor can serve as aesthetic feedback and vary in intensity or pattern. In other embodiments, vibrations can also serve a practical purpose, such as clearing debris.

In an actuation output response embodiment, an output component 160 can include an actuator, and an output response 170 can include a mechanical movement. In one embodiment, the smoking device can include one or more valves, and an output response can include an actuator that opens the one or more valves in order to release excess smoke or allow additional air to flow in. The output response of the one or more valves can be fixed, vary over time, or vary based on input 100. For example, one or more valves can open to release smoke at proper increments to create patterns in the air made up of smoke including text, graphics, or shapes like smoke rings (or any other shape). Further, one or more valves can open to allow air to flow into the stem when input sensor 110 detects that the user has stopped inhaling, allowing a portion or all of the smoke to clear from the stem.

Regardless of the output embodiment, an output response can be always on or always off, enabled or disabled in response to an input 100, or dynamically enabled or disabled relative to an input 100. Processing unit 130 can use an algorithm to determine when to enable or vary an output response based on one or more readings from an input sensor 110. For example, in a temperature sensing embodiment, processing unit 130 can monitor temperature readings and enable one or more corresponding output responses. In one embodiment, processing unit 130 can control an output response based on an absolute temperature reading crossing a threshold. In another embodiment, processing unit 130 can control an output response based on a relative change in temperature readings from a steady state, or a return to a relative steady state. In yet another embodiment, processing unit 130 can control an output response based on a rate of change of temperature readings. In another embodiment, processing unit 130 can control an output response based on a local temperature peak, detected by temperature readings increasing and then decreasing.

In at least the aforementioned embodiments, processor 130 can monitor a plurality of temperature readings over time and dynamically control an output response to track the input temperature readings. For example, when a user draws hot air through the stem, sensor 110 can read successively higher temperature readings. Processor 130 can compare the temperature readings to a threshold, and when a reading passes the threshold, processor 130 can enable or vary output response 170. If an output component is a light source, for example, processor 130 can turn on a light, vary a brightness level of the light, or vary a lighting pattern when the temperature reading passes the threshold. For other types of output components, processor 130 can control a component as otherwise disclosed in the present disclosure.

In another example, processor 130 can monitor a plurality of initial temperature readings and determine a steady state temperature level based on an average temperature reading taken during an initial period. An initial period can be set according to a preset time period that begins after a user subjects the smoking device to a heat source but before the user draws heated air through the stem. Additionally or alternatively, an initial period can include any time period during which temperature readings do not vary by more than a preset amount relative to previous readings. As a user draws heated air through the stem, processor 130 can compare the temperature readings to the steady state temperature level, and when a reading passes the steady state temperature level, processor 130 can enable or vary output response 170. If an output component is a light source, for example, processor 130 can turn on a light, vary a brightness level of the light, or vary a lighting pattern when the temperature reading passes the steady state temperature level. For other types of output components, processor 130 can control a component as otherwise disclosed in the present disclosure.

In another example, processor 130 can monitor a plurality of initial temperature readings and keep track of a rate of change between successive temperature readings. As a user draws heated air through the stem, processor 130 can compare the rate of change to a threshold rate of change, and when a monitored rate of change passes a threshold rate of change, processor 130 can enable or vary output response 170. If an output component is a light source, for example, processor 130 can turn on a light, vary a brightness level of the light, or vary a lighting pattern when the monitored rate of change passes the threshold rate of change. For other types of output components, processor 130 can control a component as otherwise disclosed in the present disclosure.

For embodiments that involve an output response being varied in intensity based on an input 100, processor 130 can determine a maximum rated intensity for an output component, and scale an output intensity from 0% to 100% of its maximum rated intensity based on readings from an input sensor 110. If an output component is a light, as a user draws heated air through the stem, processor 130 can monitor sensor readings as in the embodiments above, and vary an intensity of the light accordingly. For example, as a user draws heated air through the stem and a temperature inside the stem increases, processor 130 can vary an intensity of a light from 0% (turned off) to 100% (turned on to its highest rated brightness level). Further, as a temperature inside the stem decreases, processor 130 can vary an intensity of a light from 100% back down to 0% accordingly. Processor 130 can set a temperature to correspond with the 100% output level (in other words, a 100% temperature level) by examining past temperature peaks and setting the 100% temperature level to an average peak, a lowest, peak or a highest peak. Processor 130 can also set a 100% temperature level by predicting an input peak using a slope of temperature readings determined from successive rates of temperature change. As a monitored slope passes above one threshold (corresponding to successively faster rates of change) and then drops below a second threshold (corresponding to successively slower rates of change), processor 130 can set the 100% temperature level to the temperature level at which the slope drops below the second threshold.

User interface 150 can include electrical or mechanical components required to interact with a user. Several examples of user interface components include a touch sensor, a mechanical switch, a push button, a key pad, an LED display, and an LCD display. User interface 150 can be used to power the system on or off, as well as disable, enable, or select a desired output response. For example, a user can press a button to alternate between different output responses available in the smoking device.

System electronics 180 can be battery powered requiring low power operation controlled by power management 140. In one embodiment, low power operation can be achieved by disabling an onboard power supply after detecting a lack of user interaction. For example, processing unit 130 can automatically disable the power supply after detecting a lack of pull, draw, or inhalation for a period of time. Alternatively, or in addition, system electronics 180 can automatically detect a user interaction through input sensor 110 and power the system back on. Several examples of user interaction include a change in temperature (caused by a user igniting a smoking substance and drawing heated air through the stem, or caused by any source of heat in a vicinity of the smoking device), a change in touch level (user picks up the smoking device), and a change in motion (an accelerometer detects user moves the smoking device). Further, system electronics 180 can support manual powering on and off through use of a mechanical switch as part of user interface 150.

FIG. 2 depicts a generic structural diagram of an example smoking device 200, comprising a receptacle 210, a stem 220, a mouthpiece 230, a carburetor 240, an interface 250, and airflow direction 260. In the case of a hand pipe, receptacle 210 and stem 220 form one continuous body. When a person inhales from mouthpiece 230 while blocking carburetor 240, heated air and compounds from the smoking substance in receptacle 210 flow in direction 260 through interface 250 into stem 220 and out of mouthpiece 230. In the case of other form factors, such as hookahs, bubblers, water pipes, and bongs, receptacle 210 and stem 220 may be housed separately, yet remain connected at interface 250 with an adjoining tube or channel acting as a conduit for the air from receptacle 210 to reach stem 220. It is appreciated that the generic structural diagrams in this disclosure are not meant to be structurally limiting, other than demonstrating relative placement of the various parts of the smoking device (i.e. the receptacle and stem), as well as the direction of airflow through the various parts. For example, receptacle 210 may be on top of, underneath, to the side of, or even mechanically separated from stem 220, mouthpiece 230 may comprise additional mechanical attachments or be as simple as a hole in a side of stem 220, and each part may comprise any shape (any rectangular depictions are merely for simplicity of illustration, rather than limiting structural form factors).

As a person continues to draw smoke-filled air through interface 250, residue 270 can build up from the smoking substance in receptacle 210. Therefore, a preferred location for input sensor 110 would be in region 280, which is close to receptacle 210 but offset from interface 250, in order to avoid residue 270. An input sensor 110 such as a thermistor would preferably be placed as close to the heated smoking substance as possible. However, if the sensor is directly in line with the opening or outlet of the receptacle, residue can build up on the sensor over time causing performance degradation. Placing the sensor in region 280 can avoid residue 270, yet still be in the direct path of airflow 260. While region 280 is preferred, the scope of this embodiment can still cover any other placement of input sensor 110, as long as it is in airflow path 260, whether such path may be according to the actual structure of the smoking device. Input sensors which do not require placement in line with airflow 260 to sense temperature can be glued, molded, or otherwise attached in further locations to avoid reside 270. For example, a pyrometer or infrared thermometer does not have to be in line with airflow 260 to sense temperature allowing its placement in further isolated locations to avoid any residue.

In one embodiment, an input sensor 110 may be placed through a hole in the smoking device and sealed with any type of secondary material such as food grade silicon in order to prevent air leakage. In another embodiment, an input sensor 110 may be sealed into the smoking device using the primary material of the smoking device itself. An advantage of this embodiment is minimization of foreign or secondary materials from the smoke path, limiting any potential contamination of the smoking substance. As an example of this embodiment, the input sensor can be sealed into a glass smoking device using glass. To prevent damage to any portion of the input sensor which cannot tolerate the heat required to seal with glass, high heat tolerating conductors can be used to penetrate the actual seal. The sensor can be attached to these conductors post-sealing.

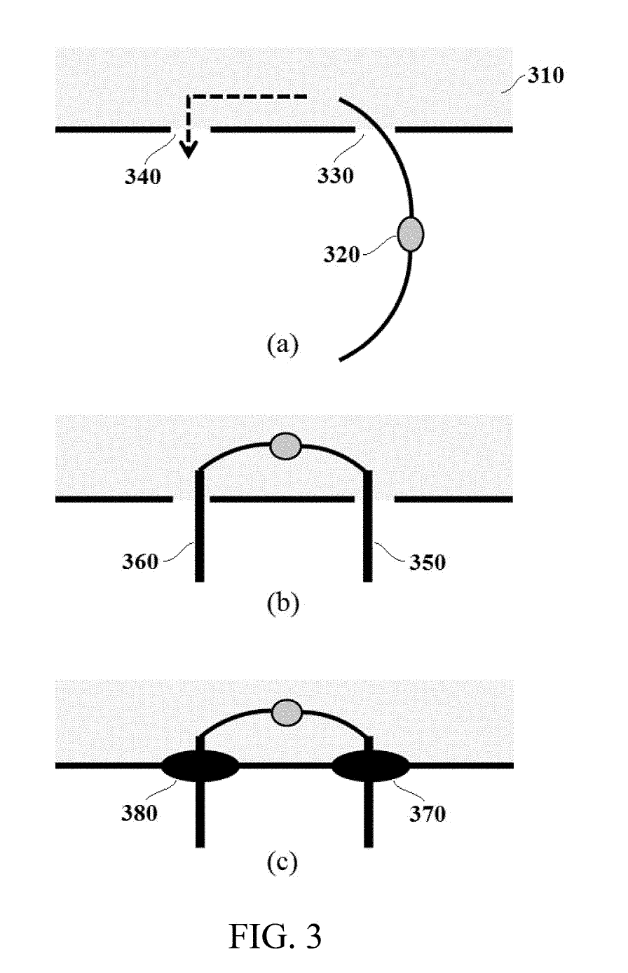

FIG. 3 depicts an embodiment for sealing an input sensor into an interior region 310 of an example smoking device made out of glass or a similar substance. An input sensor such as a thermistor or thermocouple can comprise a sensing element 320 which can be threaded through holes 330 and 340 as shown in step (a). High heat tolerating conductors 350 and 360, attached to sensing element 320, can be used to protect sensing element 320 as shown in step (b). Once the sensor and its conductors are in place, the conductors can be sealed using the primary material of smoking device as the sealant, or any other sealing material, at points 370 and 380, as shown in step (c).

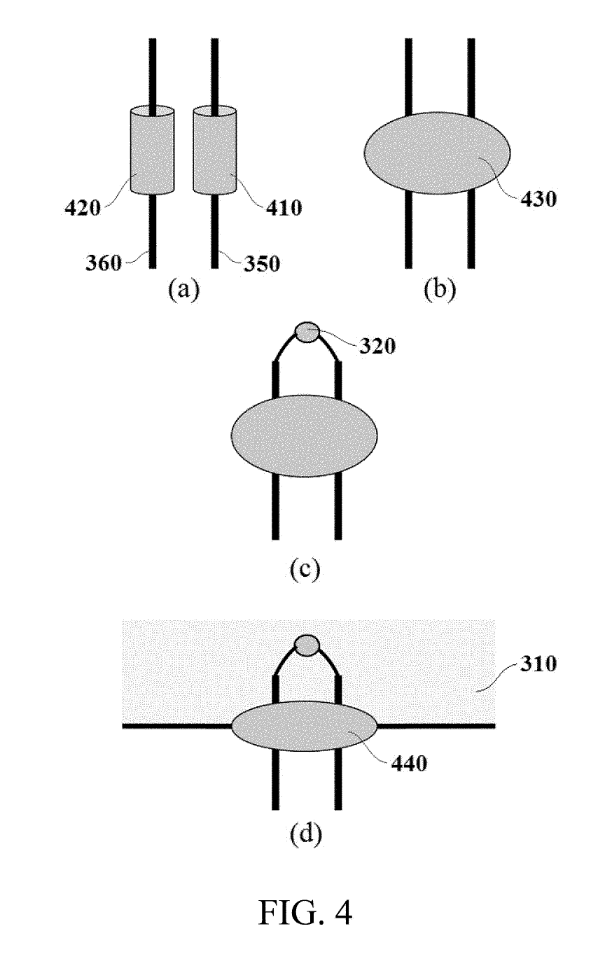

FIG. 4 depicts another embodiment for sealing an input sensor into an interior region 310 of an example smoking device made out of glass. High heat tolerating conductors 350 and 360 can be inserted into glass tubes 410 and 420 as in step (a), which can then be sealed together into a single glass seal 430 as in step (b) using heat or any other sealing technique. Sensing element 320 can be attached to the pre-molded conductors as in step (c), and then sealed into a hole in the smoking device using the primary material of the smoking device as the sealant, or any other sealing material, at point 440 as shown in step (d).

In an embodiment of a smoking device made out of metal, a sensor can be sealed into the metal smoking device by soldering or welding the sensor into the device using the same metal material. If an electrically conductive metal is used, conductive portions of the sensor must be insulated. If a ground is required, a conductive portion of the smoking device can be mated to ground so only one insulated path is required from the sensor.

The following discussion describes various methods and structural components which can be used alone or in combination in order to integrate system electronics 180 with a body of the smoking device, the body comprising at least a stem. For a hand pipe, the body can comprise the stem and the receptacle; for other types of smoking devices where the receptacle and stem are separated, the body can comprise any combination of receptacle, stem, and other pieces of hardware necessary for a smoking operation. System electronics 180 can optionally be enclosed in a housing that can be permanently affixed (for example, with a glue method) or removably affixed (for example, with a magnetic, mechanical, or threaded method) to a body of the smoking device. Advantages of a removable housing include easier access for maintenance, cleaning, and battery replacement.

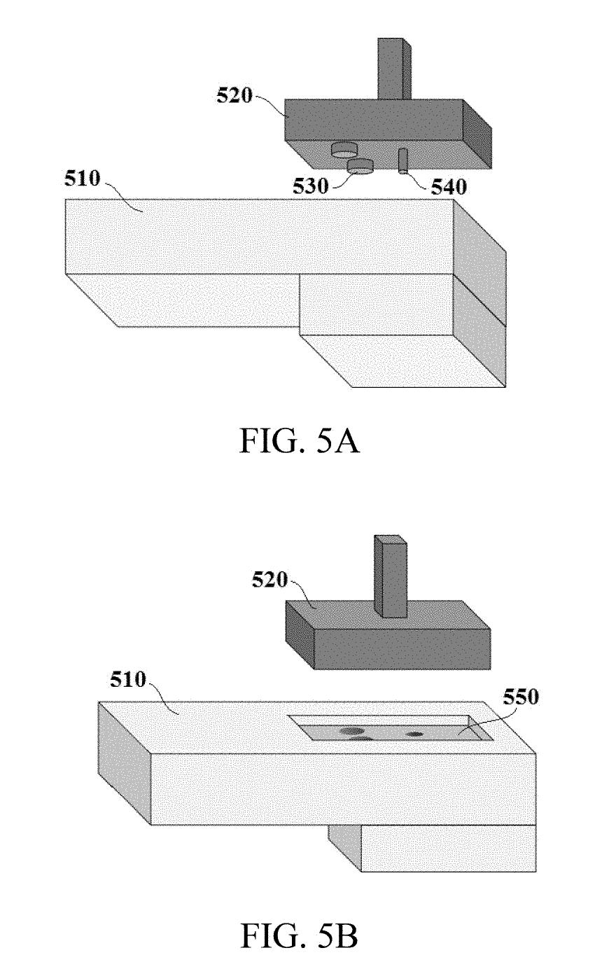

FIGS. 5A and 5B depict two views of an embodiment for joining a housing of electronic components to a glass body of a smoking device by using a stamp. Body 510 can be integrated with the housing using a stamping or debossing method where a branding iron, mold, stamp, or any heat tolerant surface 520 representing the physical layout of the electronics and housing is pressed into heated glass body creating indentation 550. Mold/stamp 520 can be used to create the proper indentation or surface necessary to mount and integrate the housing onto the body. Mold/stamp 520 can contain protrusion(s) 530 for various components including any portion of the main housing, attachment magnets, electronic components, alignment or guiding plates, as well as marker(s) 540 for where to drill any holes in the glass.

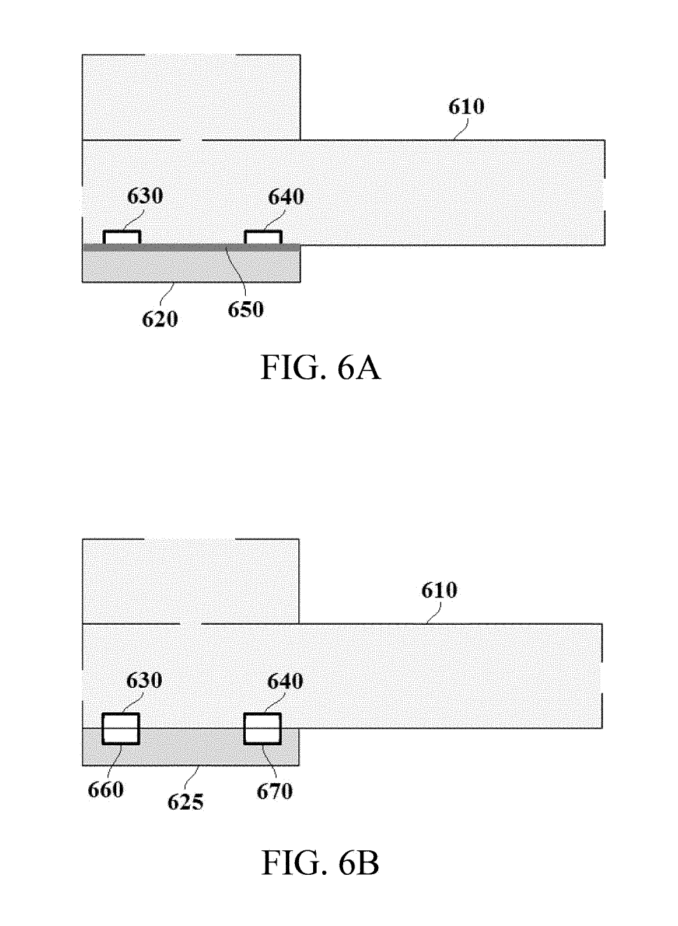

FIGS. 6A and 6B depict two embodiments for joining a housing of electronic components to a body of a smoking device by using one or more magnets. Body 610 and housing 620 can be magnetically joined. In an embodiment depicted in FIG. 6A, magnets 630 and 640 can be affixed to body 610, and ferromagnetic layer 650 can be affixed to housing 620. The affixing can be achieved with glue or any material that can affix different materials such as metal and glass to each other. The magnetic coupling of magnets 630 and 640 to ferromagnetic layer 650 can result in a sturdy, yet easily separable connection between body 610 and housing 620. Alternatively, the magnets can be affixed to the housing and the ferromagnetic layer can be affixed to the body. In an embodiment depicted in FIG. 6B, magnets 630 and 640 can be affixed to body 610, and corresponding magnets 660 and 670 can be affixed to housing 625. The magnetic coupling of magnets 630 and 640 to corresponding magnets 660 and 670 can result in a sturdy, yet easily separable connection between body 610 and housing 625. In embodiments which require gluing components to glass, an ultraviolet (UV) light-activated optically clear adhesive (OCA) can be used to maintain transparency.

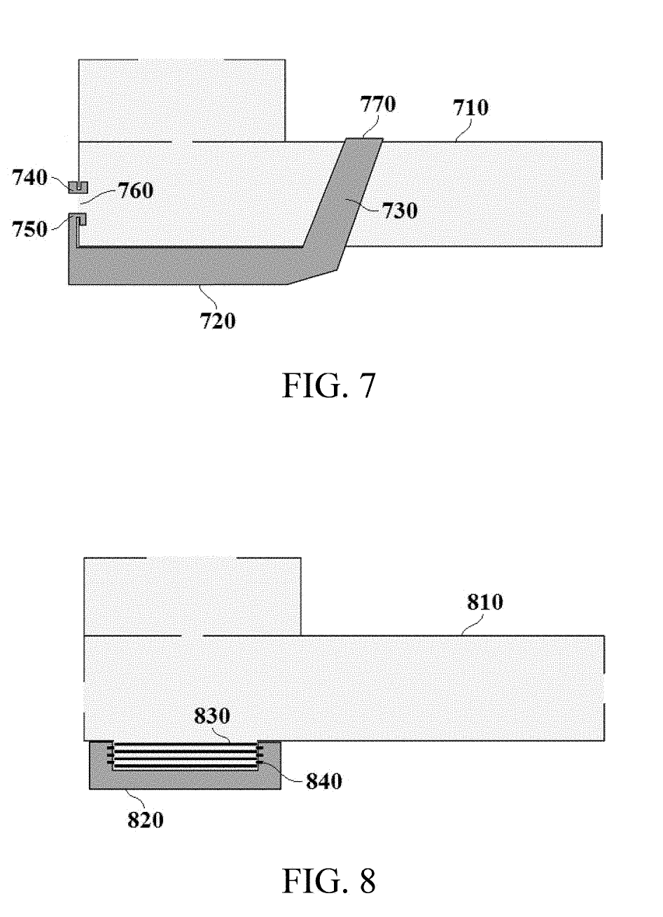

FIG. 7 depicts an embodiment for joining a housing of electronic components to a body of a smoking device by using a strap. Body 710 and housing 720 can be joined by strap 730 for additional support. Housing 720 may include features that physically interface with body 710. Features may include rigid or flexible elements that constrain housing 720 to body 710. These elements may interface with any portion of the body including the stem. The elements may interface with features of the body that are specifically designed for mounting, or the elements may incorporate cosmetic design features. One example feature can comprise carburetor hole 760 which may be enhanced to accommodate an attachment point with food grade silicone grommet features 740 and 750, which maintain the functionality of the carburetor while providing mechanical support for housing 720. Strap 730 may also comprise a wrapping portion 770 that extends around a diameter of body 710 that, while in combination with features 740 and 750, provide additional support for housing 720. Of course, one or both of features 740 and 750 are not required for wrapping portion 770 of strap 730 to be effective at securing the housing to the body, and wrapping portion 770 is not required for features such as 740 and 750, or additional features on other areas of body 710, to be effective at securing the housing to the body.

FIG. 8 depicts an embodiment for joining a housing of electronic components to a body of a smoking device by using threading. Body 810 and housing 820 can be joined by screwing housing threads 840 onto body threading 830. (Conversely, the threads can be on the body and the threading can be on the housing.) Housing threads 840 can be screwed onto body 810 which itself contains threading 830 which can be molded or shaped into the material of the body. For example, a housing can be screwed onto a glass body in the same manner a cap is screwed onto a glass jar.

In another embodiment, a housing of electronic components can be joined to a body of a smoking device with glue. The body and the housing can be joined by using UV OCA, which cures transparent allowing light to pass through.

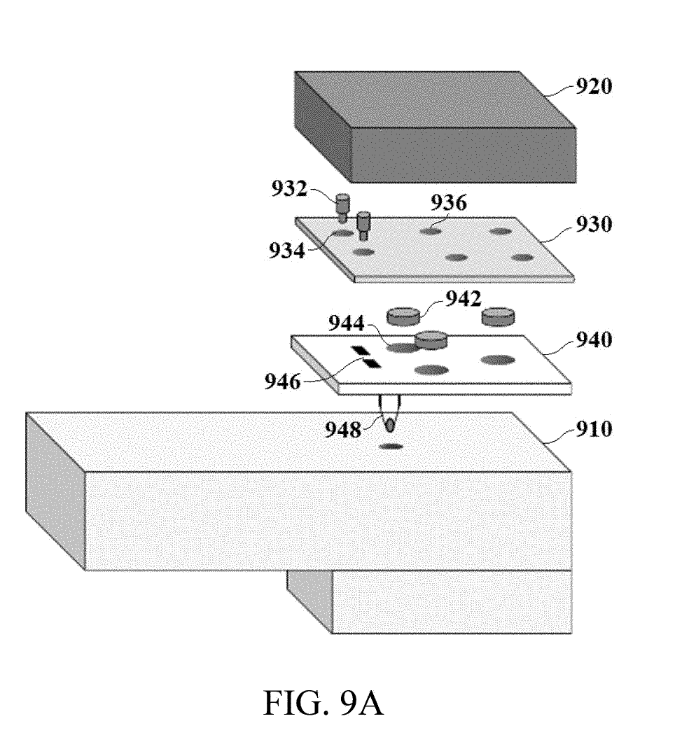

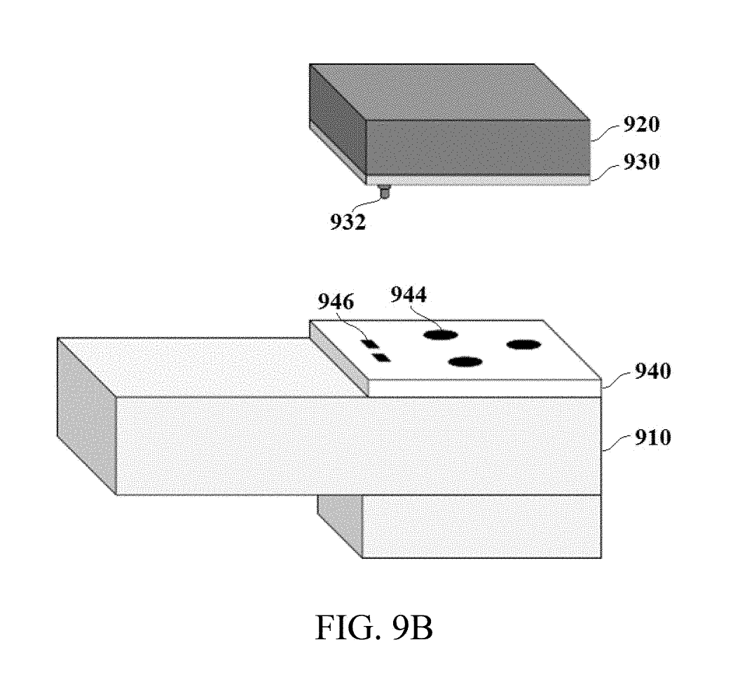

FIGS. 9A and 9B depict embodiments for joining a housing of electronic components to a body of a smoking device by using a mounting plate. Housing 920, affixed to an interface layer 930, can be joined to body 910 using mounting plate 940. The mounting plate can be affixed to the body in order to present a flat surface for attachment to the housing. Any minor imperfections in the body's surface can be hidden using varying thickness of OCA between the mounting plate and the body.

To enable user detachment of housing 920 from mounting plate 940, mounting plate 940 can expose access through sensing element interface 946 to any sensing element 948 integrated into body 910. Sensing element interface 946 can provide a detachable connection between body 910 containing one or more integrated sensing elements, and housing 920 containing system electronics 180. For example, sensing element interface 946 can comprise conductive metal, or conductive magnets connected to a thermistor in body 910. The sensing element interface can expose a conductive surface which can then make an electrical connection to either spring loaded conductive elements 932 through access holes 934, or corresponding electrically conductive magnetic elements 942 through access holes 944. Further, conductive elements 932 and 942 can be electrically coupled to system electronics 180 in housing 920. In another embodiment, the sensing element interface can include mechanical tubing access which connects the body to an input sensor such as a pressure sensor.

In another embodiment, housing 920 and mounting plate 940 can be attached by using mechanical features or magnets 942 for retention. The magnets, which can be affixed to body 910 through interface 944 using glue, can be fully encased in the thickness of the mounting plate to reduce profile. The magnets can attach to interface layer 930 which can be made up of ferromagnetic material. Additionally or alternatively, housing 920 can contain opposing magnets in order to attach to magnets 942 in mounting plate 940. Conversely, the magnets can be affixed to the housing 920 and the ferromagnetic layer can be affixed to the body 910.

In another embodiment, interface layer 930 and mounting plate 940 can include holes 936 to expose light from a light source in housing 920 so that the light can enter body 910. Holes 936 are depicted in interface layer 930 in FIG. 9A for descriptive purposes and can be included in any number or pattern. In practice, holes 936 should also be included in mounting plate 940 so that they align with the corresponding holes in interface layer 930 in order to allow light to enter body 910. Alternatively, interface layer 930 or mounting plate 940 can be made out of transparent materials which allow light to pass through without needing holes. A transparent mounting plate can be used to optically manipulate the light which passes through it by directing, focusing, or diffusing the light as necessary so that a direction, focus level, and brightness level of the light is within a desired range.

The following discussion describes various embodiments relating to a glass smoking device. A glass body can be designed to specifically route, reflect, diffuse, or focus light in aesthetically pleasing ways. Using one or more light sources as output components, the light can behave in a variety of ways. One or more sections of uranium glass or UV reactive glass of the same or different reactive color can be molded, blown, or otherwise attached to the body, enabling the glass body to respond to infrared, ultra-violet, or black-light sources. In an embodiment comprising a plurality of sections of UV reactive glass, each section can react to a UV light source by lighting up in the same or different color, based on the composition of the glass. The light sources can illuminate one or more sections of the body based at least on the various example algorithms previously described.

In some embodiments, software control of black-light, infrared, or ultra-violet sources can intelligently illuminate different sections of glass generating a physically distributed animation. For example, glass which reacts to black-light, infrared, or ultra-violet light (i.e. reactive glass) can be affixed to glass that does not react to black-light, infrared, or ultra-violet light (i.e. unreactive glass). When the black-light, infrared, or ultra-violet light is enabled, the reactive glass emits colored light while the unreactive glass does not. This creates an output response where some pieces of glass glow where other pieces do not.

In some embodiments, crushed, indented, or etched glass can be used to accent and diffuse the one or more light sources in specific areas of the body based at least on the various example algorithms previously described.

In some embodiments, glass rods routed through the body during manufacturing can be used as light pipes to enable illumination of specific portions of the glass. For example a light rod, optionally colored, can be integrated into the body such that it originates at a lighting output source and routes light as a pipe. Software can be used to enable or disable individual light sources to present light only in specific areas of glass through these pipes, based at least on the various example algorithms previously described.

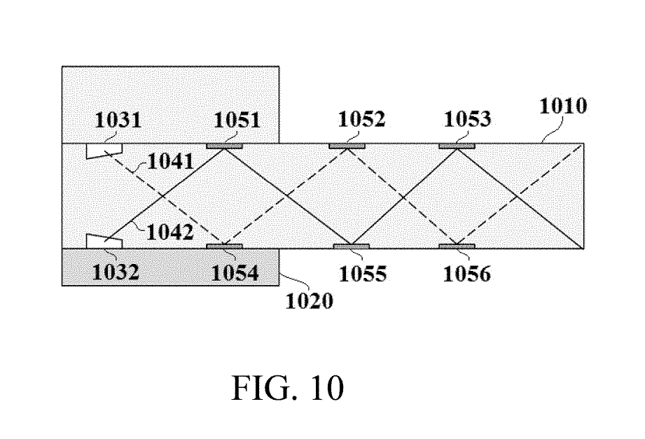

FIG. 10 depicts another embodiment which includes strategically placed mirrors 1051-1056 in body 1010 which can be used to route, reflect, and distribute laser light from one or more lasers 1031 and 1032 through the body along paths 1041 and 1042. Mirrors can be glued, molded, or otherwise attached to glass apparatus. The laser lighting can be made visible to a user when smoke is present inside the body. Software and electronic components in housing 1020 (or in the body itself) can intelligently control the lasers to turn on only when smoke is present by using an input sensor.

As used herein, the term “or” is intended to be interpreted as “or” or “and” unless explicitly stated otherwise. For example, “A or B” should be interpreted as “A only, B only, or both A and B” unless explicitly stated otherwise. Further, “A, B, or C” should be interpreted as “A only; B only; C only, A and B; B and C; A and C; or A, B, and C” unless explicitly stated otherwise. Similarly, the term “and/or” is intended to be interpreted as “or” or “and” as previously described in this paragraph, unless explicitly stated otherwise.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A smoking apparatus, comprising:
a housing comprising a first chamber and a second chamber coupled to the first chamber, the first chamber configured to hold a smoking substance and comprising an output end, the second chamber comprising an input end adjacent to the output end of the first chamber, the second chamber configured to receive air from the output end of the first chamber into the input end;
an interface between the output end of the first chamber and the input end of the second chamber, the interface configured to retain the smoking substance while allowing air to pass through the output end of the first chamber into the input end of the second chamber;
a temperature sensor, coupled to the housing, configured to sense a first temperature level of the air in the second chamber, the temperature sensor further configured to output a first temperature signal in response to sensing the first temperature level of the air in the second chamber;
a processor, coupled to the temperature sensor, configured to receive the first temperature signal, determine whether the first temperature signal is above a first threshold, and output a first control signal in response to the first temperature signal being above the first threshold;
a driver, coupled to the processor, configured to receive the first control signal and output a first output signal in response to receiving the first control signal;
an electronic component comprising a light source, a speaker, a motor, and/or an actuator, the electronic component configured to receive the first output signal and output a first output response comprising a first light mode, a first sound, a first vibration, and/or a first mechanical movement, in response to receiving the first output signal.

2. The smoking apparatus of claim 1,
wherein the temperature sensor is further configured to output a second temperature signal in response to sensing a second temperature level different from the first temperature level;
wherein the processor is further configured to output a second control signal in response to determining that either the second temperature signal is below the first threshold or the second temperature signal is above a second threshold;
wherein the driver is further configured to output a second output signal in response to receiving the second control signal; and
wherein the electronic component is further configured to output a second output response in response to receiving the second output signal, wherein the second output response comprises a second light mode, a second sound, a second vibration, and/or a second mechanical movement.

3. The smoking apparatus of claim 2,
wherein the driver comprises a light emitting diode (LED) driver and/or a laser driver,
wherein the electronic component comprises at least one light source, the at least one light source comprising an LED and/or a laser;
wherein the first output response comprises the first light mode, and the second output response comprises the second light mode; and
wherein the first light mode and the second light mode are configured to differ in brightness level, color, and/or lighting pattern.

4. The smoking apparatus of claim 3,
wherein the first light mode and the second light mode are configured to differ in brightness level; and
wherein a brightness level of the second light mode is configured to be:
i) lower than a brightness level of the first light mode when the second temperature signal is below the first threshold,
ii) equal to a brightness level of the first light mode when the second temperature signal is above the first threshold and below the second threshold, and/or
iii) higher than a brightness level of the first light mode when the second temperature signal is above the second threshold.

5. The smoking apparatus of claim 3,
wherein the first light mode and the second light mode are configured to differ in lighting pattern; and
wherein each lighting pattern differs in:
i) an order in which a first light source and/or a second light source are turned on and off,
ii) an order in which a first light source and/or a second light source are driven to have higher and lower brightness levels, and/or
iii) an order in which a first light source and/or a second light source are driven to have different colors.

6. The smoking apparatus of claim 2,
wherein the driver comprises an audio codec;
wherein the electronic component comprises a speaker,
wherein the first output response comprises a first sound and the second output response comprises a second sound; and
wherein the first sound and the second sound are configured to differ in selection and/or volume.

7. The smoking apparatus of claim 2,
wherein the driver comprises a motor driver;
wherein the electronic component comprises a motor;
wherein the first output response comprises a first vibration and the second output response comprises a second vibration; and
wherein the first vibration and the second vibration are configured to differ in length, intensity, and/or pattern.

8. The smoking apparatus of claim 2,
wherein the driver comprises an actuator driver;
wherein the electronic component comprises an actuator;
wherein the first output response comprises a first mechanical movement and the second output response comprises a second mechanical movement; and
wherein the first mechanical movement and/or the second mechanical movement are configured to open a valve in the second chamber.

9. A smoking apparatus, comprising:
a container comprising a first opening and a first interface section;
a channel comprising a second opening and a second interface section, the second interface section being coupled to the first interface section;
a temperature sensor, coupled to the channel, configured to output a temperature reading based on an air temperature inside of the channel;
a processor, coupled to the temperature sensor, configured to output a control signal based on the temperature reading;
a light source configured to operate in one of a first mode and a second mode based on the control signal.

10. The smoking apparatus of claim 9, wherein the processor is configured to output the control signal based on a comparison of the temperature reading to a threshold.

11. The smoking apparatus of claim 9, wherein the processor is configured to output the control signal based on a rate of change between the temperature reading and a subsequent temperature reading.

12. The smoking apparatus of claim 9, wherein the processor is further configured to output a subsequent control signal based on a temperature peak, and wherein the light source either reverts to a prior mode or enters a new mode based on the subsequent control signal.

13. The smoking apparatus of claim 9, further comprising:
a flow sensor, coupled to the channel, configured to detect air flowing from the first opening through the first interface section, into the second interface section, and out through the second opening; and
wherein the flow sensor is further configured to output a flow reading based on a level of air flow through the channel.

14. The smoking apparatus of claim 13, wherein the processor is further configured to accept temperature readings in response to the flow reading being above a threshold, and discard temperature readings in response to the flow reading being below the threshold.

15. The smoking apparatus of claim 13, wherein the processor is further configured to determine a rate of change based on the flow reading and a subsequent flow reading, accept temperature readings in response to the rate of change being above a threshold, and discard temperature readings in response to the rate of change being below the threshold.

16. A smoking apparatus, comprising:
a container comprising a first opening and a first interface section;
a channel comprising a second opening and a second interface section, the second interface section being coupled to the first interface section;
a sensor, coupled to the channel, configured to output a reading based on a condition of the channel;
a processor, coupled to the temperature sensor, configured to output a control signal based on the reading; and
a light source, coupled to the container and/or the channel, the light source configured to operate in one of a first mode and a second mode based on the control signal, wherein the first mode and the second mode differ in brightness, color, and/or pattern.

17. The smoking apparatus of claim 16, wherein the sensor is an air flow sensor, and the reading is a level of air flow inside the channel.

18. The smoking apparatus of claim 16, wherein the sensor is a pressure sensor, and the reading is a level of air pressure inside the channel.

19. The smoking apparatus of claim 16, wherein the sensor is a light sensor, and the reading is a level of light inside the channel.

20. The smoking apparatus of claim 16, wherein the sensor is a touch sensor, and the reading is a level of hand proximity to the channel.
